(19) United States
(12) Patent Application Publication
(10) Pub. No.: US 2007/0195955 A1
(43) Pub. Date: Aug. 23, 2007

(54) Apparatus and method for providing secure end-to-end communications in a wireless network

(76) Inventors: Stephen Cochran, San Diego, CA (US); Mark Maggenti, Del Mar, CA (US)

Correspondence Address: QUALCOMM INCORPORATED, 5775 MOREHOUSE DR., SAN DIEGO, CA, 92121, US

(21) Appl. No.: 11/360,179

(22) Filed: Feb. 22, 2006

(51) Int. Cl. H04K 1/00

(52) U.S. Cl. 380/247

(57) ABSTRACT

An apparatus and method for providing secure end-to-end communications over a wireless network. Audio transmissions are encrypted at the sending wireless device before being transmitted over the wireless network. Encrypted audio messages received from the wireless network are decrypted at the receiving wireless device, and then played to a user. The encryption and decryption are performed by a memory resident applet at the wireless device, and the user may selectively download a newer version of an applet with a different encryption algorithm from a server.

### BACKGROUND OF THE INVENTION

1. Field of the Invention

The present invention generally relates to wireless telecommunications, and more specifically, relates to a system and method for providing a secure communication in a wireless network.

2. Description of the Related Art

Technology advancement has made mobile telephones or wireless communications devices inexpensive and accordingly ubiquitous. As wireless telecommunication devices are manufactured with greater processing ability and storage, they also become more affordable. The coverage area of wireless networks has also expanded to cover most of the urban areas. Now many businesses are conducted using wireless communications devices over the wireless network and often sensitive information are communicated over the wireless telephones. These business calls or exchange of sensitive information generally are not protected and open to interception by anyone who has a special radio scanner capable of picking upover-the-air digital transmissions.

Some wireless telephones, such as the CONDOR wireless telephone, have used encryptions to protect their audio transmissions. However, such encryption is generally done either by an encryption circuit built into the wireless telephone or by an encryption card that is inserted into the wireless telephone. Both of these solutions are expensive and antiquated; however, neither of which can be easily updated with newer encryption algorithms or methods.

Therefore, it is desirous to have an apparatus and method that provide inexpensive and flexible secure end-to-end communications over a wireless network, and it is to such apparatus and method the present invention is primarily directed.

### SUMMARY OF THE INVENTION

Briefly described, an apparatus and method of the invention provide secure end-to-end communications over a wireless network. Audio transmissions are encrypted before being transmitted over the wireless network. Encrypted audio messages received from the wireless network are decrypted, and then played to a user. The encryption and decryption are performed by a memory resident applet and the user may download a newer version of an applet with a different encryption algorithm from a server.

In one embodiment, there is an apparatus that is capable of providing secure end-to-end audio communications in a wireless communication network. The apparatus includes a transceiver for transmitting and receiving secure audio messages from the wireless communication network, a controller in communication with the transceiver for receiving the secure audio messages from the transceiver, a user interface unit in communication with the controller for interfacing with a user, and a computer-readable storage medium in communication with the controller. The computer-readable storage medium stores a computer program for encrypting and decrypting audio communications. The computer program includes computer instructions that when executed by the controller performs the steps of receiving audio communications from the user, and encrypting the audio communications into secure audio messages according to a predefined algorithm.

In another embodiment, there is a method for providing secure audio communications on a wireless communication device in communication with a wireless communication network and exchanging secure audio messages with other devices across the wireless communication network, wherein the wireless communication device having computer readable memory on which a computer program is stored. The computer program includes computer executable instructions when executed by the wireless communication device performs the steps of receiving an audio communication from a user, encrypting the audio communication into secure audio messages according to a predefined algorithm, and transmitting the secure audio messages from the wireless communication device to the wireless communication network.

The present system and methods are therefore advantageous as they provide secure end-to-end communications over a wireless network using updateable encryption algorithm and protocols. Other advantages and features of the present invention will become apparent after review of the hereinafter set forth Brief Description of the Drawings, Detailed Description of the Invention, and the Claims.

### BRIEF DESCRIPTION OF THE DRAWINGS

FIG. 1 depicts an exemplary embodiment of a communication network.

FIG. 2 is an exemplary embodiment of an architecture of a wireless device implementing secure end-to-end communications.

FIG. 3 is an exemplary embodiment 6f a wireless device process for engaging in secure communications.

### DETAILED DESCRIPTION OF THE INVENTION

In this description, the terms “communication device,” “wireless device,” “wireless communications device,” “PTT communication device,” “handheld device,” and “user device” are used interchangeably. The term “application” as used herein is intended to encompass executable and nonexecutable software files, raw data, aggregated data, patches, and other code segments. The term “exemplary” is meant only as an example, and does not indicate any preference for the embodiment or elements described. Further, like numerals refer to like elements throughout the several views, and the articles “a” and “the” includes plural references, unless otherwise specified in the description.

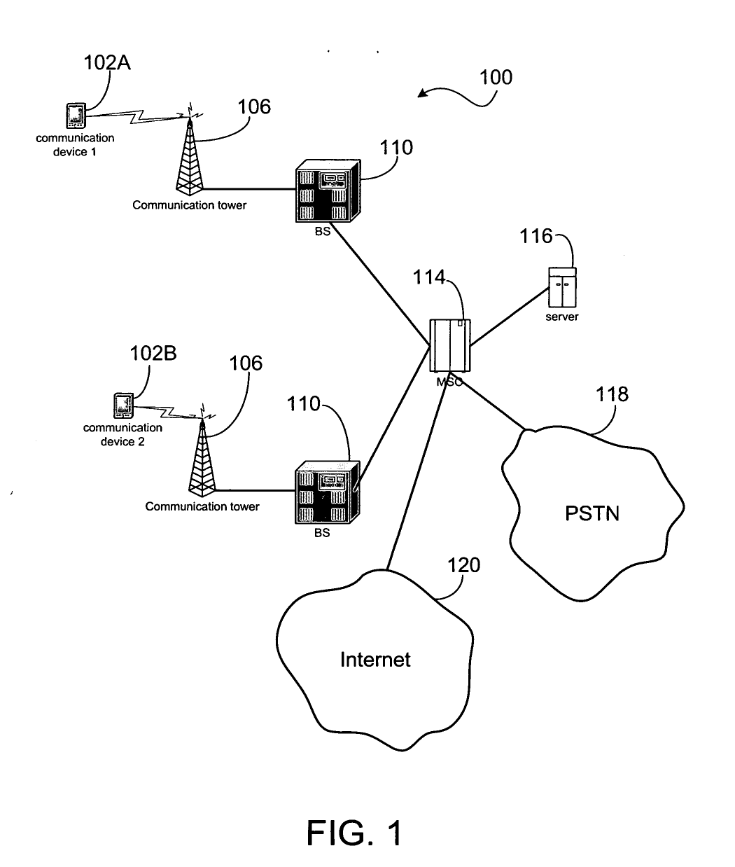

In overview, the present system and method provide secure end-to-end communications over a wireless network through an inexpensive and flexible software module. FIG. 1 depicts a communication network 100. The communication network 100 includes one or more communication towers 106, each connected to a base station (BS) 110 and serving users with communication device 102[A-B]. The communication device 102[A-B] can be cellular telephones, pagers, personal digital assistants (PDAs), laptop computers, or other hand-held, stationary, or portable communication devices that support push-to-talk communications. The commands and data input by each user are transmitted as digital data to a communication tower 106. The communication between a user using a communication device 102[A-B] and the communication tower 106 can be based on different technologies, such code division multiple access (CDMA), time division multiple access (TDMA), frequency division multiple access (FDMA), the global system for mobile communications (GSM), or other protocols that may be used in a wireless communications network or a data communications network.

The audio communications are digitized and transmitted through data packets over the communication network 100. The wireless communication device 102 sends and receives audio data packets on an assigned communication channel and control data are sent and received through a reverse access channel. The data packets from each device 102[A-B] is sent from the communication tower 106 to a base station (BS) 110, and forwarded to a mobile switching center (MSC) 114, which may be connected to a public switched telephone network (PSTN) 118 and the Internet 120. The MSC 114 may be connected to a server 116 that supports special audio communication features in the communications network 100. Optionally, the server 116 may be part of the MSC 114. The data packets are forwarded by the server 116 to the receiving wireless device 102[A-B] where an audio stream will be reconstructed based on the data in the data packets. The data packets are transmitted between the wireless device 102[A-B] and the BS 106 according to a predefined protocol such as Real-time Transport Protocol (RTP), Transfer Control Protocol/Internet Protocol (TCP/IP), or other suitable protocols.

A user at the communication device 102A can communicate with a user at the wireless communication device 102B through audio communications. When the user at the wireless communication device 102A wants to talk to the user at the communication device 102B, he dials the telephone number for the communication device 102B and a communication channel is established between the communication devices 102A and 102B. The user speaks into his wireless device 102A and his audio message is received and encrypted by a software application, and then transmitted to the receiving party through the wireless network.

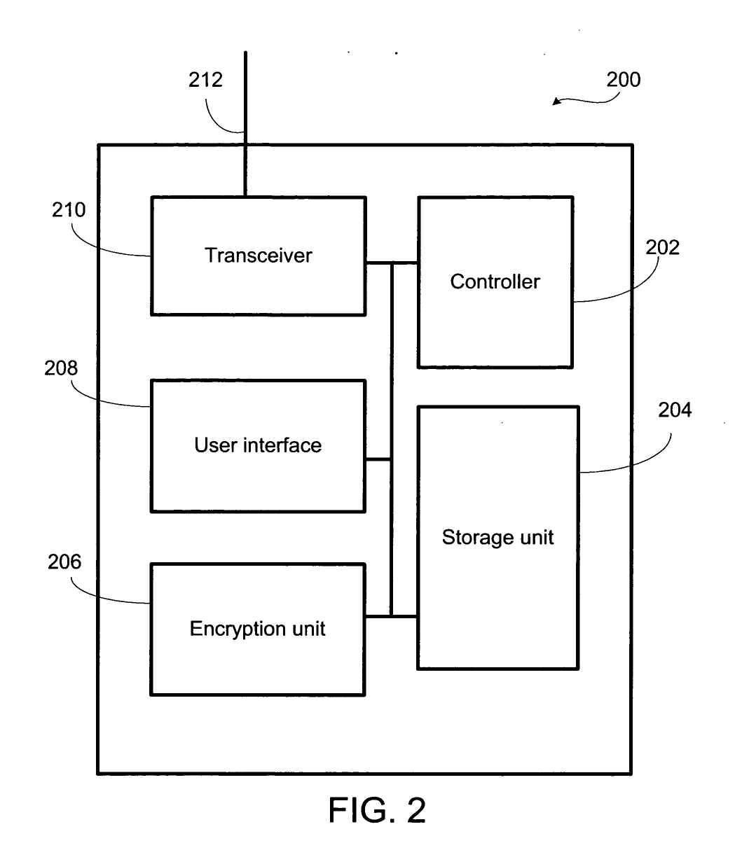

FIG. 2 illustrates a block diagram 200 of one embodiment of a wireless handset 102. The wireless handset 102 includes a controller 202, a storage unit 204, an encryption unit 206, a user interface unit 208, a transceiver 210, and an antenna 212. The controller 202 can be hardware, software, or a combination thereof. The controller 202 oversees communications with a communication server. The storage unit 204 may store connection or communication related information. The encryption unit 206 encrypts audio received from the user and decrypts encrypted communications received from the wireless network. The encryption unit 206 is an application software and preferably developed according the Binary Runtime Environment for Wireless (BREW) standard of Qualcomm®.

The encryption unit 206 may be encrypt the audio using any of well known encryption algorithms, such as Advanced Encryption Standard (AES), Diffie-Hellman, or any other commercially available type-4 commercial encryption algorithms. The encryption unit 206 can be a memory resident application and can also be a standalone application or part of an audio application that interfaces with the user. Optionally, the encryption unit 206 may be replaced with a newer version downloaded from a server and the newer version may employ a different encryption algorithm. The user interface unit 208 controls hardware, such as speaker, microphone, and display unit used for communication with the user. The transceiver 210 transmits and receives audio communications and control signals in form of radio signals to and from a communication tower 106.

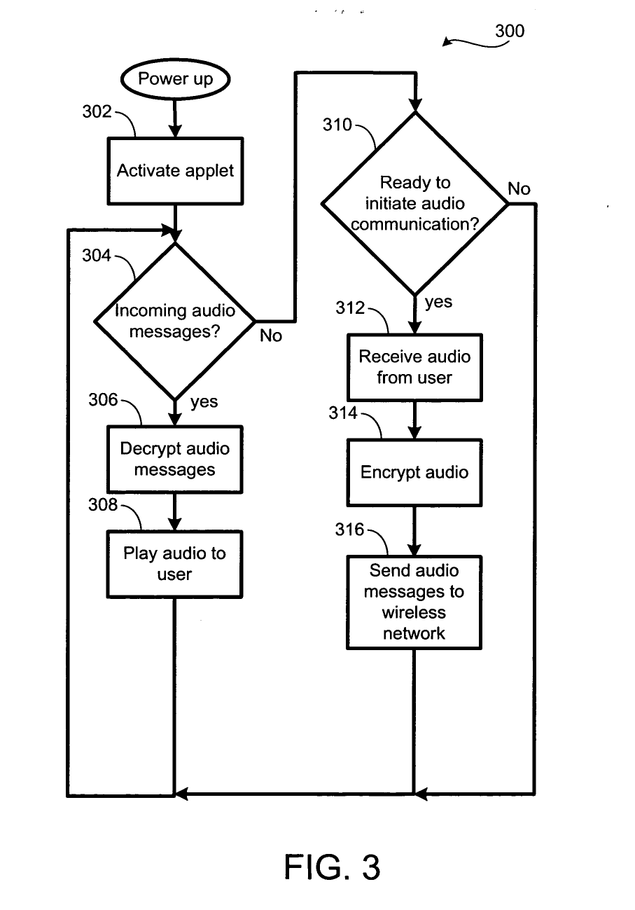

FIG. 3 is a flow chart of an exemplary of a user device process 300. Upon powering up, the user device activates an applet (application) that interfaces with the user, step 302. After powering up and exchanging information with the wireless network, the user device starts to check whether there any incoming call, step 304, or outgoing call, step 306. If there is an incoming call, the user device receives the incoming encrypted audio messages (typically in a series of packets), decrypts them, step 306, and plays the decrypted audio to the user, step 308. If the user is ready to make an audio call, the user device receives the audio from the user, step 312, and encrypts the audio according to a predefined encryption algorithm, step 314. After the audio is encrypted, it is sent to the receiving party through the wireless network, step 316.

The encryption unit 206 can be easily replaced with a version that employs a different encryption algorithm. When a newer version of encryption unit 206 is available for download, the server may notify the user device through a control message. Alternatively, the user device may periodically check for the availability of newer applications including the newer encryption unit. When the newer encryption unit is available, the user device requests a download, and the new encryption unit is then sent from the server to the user device. The new encryption unit is stored in the storage unit 204 and used to replace the existing encryption unit. The audio communication is then encrypted by the new encryption unit. This way, the user device can provide a different encryption algorithm without any hardware replacement.

The following is a simplified description of a use scenario of the invention. John is carrying his wireless telephone 102A and decides to makes a call to Mary. John dials Mary's wireless telephone 102B number and after a brief delay Mary answers the call. A communication channel is established between John's wireless telephone 102A and Mary's wireless telephone 102B. After Mary answers the call, John starts to speak into his wireless device. John's voice is captured by his wireless device and an encryption applet inside his wireless telephone encrypts John's voice. The encrypted audio is then transmitted to Mary's wireless telephone through the wireless network. Because the audio is encrypted, the content of the audio is secure against illegal interception. After the encrypted audio is received by Mary's wireless telephone, the encryption applet resident in Mary's wireless telephone will decrypt the incoming audio, and then plays it to Mary. Any communication from Mary to John will also go through the process of encryption and decryption.

In view of the method being executable on a wireless service provider's computer device or a wireless communications device, the method can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In the context of FIG. 3, the steps illustrated do not require or imply any particular order of actions. The actions may be executed in sequence or in parallel. The method may be implemented, for example, by operating portion(s) of the wireless network, such as a wireless communications device or the server, to execute a sequence of machine-readable instructions. The instructions can reside in various types of signal-bearing or data storage primary, secondary, or tertiary media. The media may comprise, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. An apparatus capable of providing secure end-to-end audio communications in a wireless communication network, the apparatus comprising:
a transceiver for transmitting and receiving secure audio messages from the wireless communication network;
a controller in communication with the transceiver for receiving the secure audio messages from the transceiver;
a user interface unit in communication with the controller for interfacing with a user; and
a computer-readable storage medium in communication with the controller, the computer-readable storage medium storing a computer program for encrypting and decrypting audio communications, the computer program comprising computer instructions that when executed by the controller performs the steps of:
receiving audio communications from the user, and
encrypting the audio communications into secure audio messages according to a predefined algorithm.

2. The apparatus of claim 1, wherein the computer program further performs the steps of:
receiving the secure audio messages from the controller, and
decrypting the secure audio messages into audio communications according to the predefined algorithm.

3. The apparatus of claim 1, wherein the computer program is compatible with the Binary Runtime Environment for Wireless (BREW) standard.

4. The apparatus of claim 1, wherein the predefined algorithm is a type-4 encryption algorithm.

5. The apparatus of claim 1, wherein the predefined algorithm is an Advanced Encryption Standard compatible algorithm.

6. A method for providing secure audio communications on a wireless communication device in communication with a wireless communication network and exchanging secure audio messages with other devices across the wireless communication network, wherein the wireless communication device having computer readable memory on which a computer program is stored, the computer program having computer executable instructions when executed by the wireless communication device performs the steps of:
receiving an audio communication from a user;
encrypting the audio communication into secure audio messages according to a predefined algorithm; and
transmitting the secure audio messages from the wireless communication device to the wireless communication network.

7. The computer program of claim 6, further performs the steps of:
receiving secure audio messages from the wireless network;
decrypting the secure audio messages into audio communications; and
playing the audio communications to the user.

8. The computer program of claim 6, wherein the predefined algorithm is a type-4 encryption algorithm.

9. The computer program of claim 6, wherein the predefined algorithm is an Advanced Encryption Standard compatible algorithm.

10. A computer-readable medium on which is stored a computer program for providing secure audio communications in a wireless network, wherein the secure audio communications are transmitted between wireless communication devices across the wireless network, the computer program comprising computer instructions that when executed by a wireless communication device performs the steps of:
receiving an audio communication from a user;
encrypting the audio communication into secure audio messages according to a predefined algorithm; and
transmitting the secure audio messages from the wireless communication device to the wireless communication network.

11. The computer program of claim 10, further performs the steps of:
receiving secure audio messages from the wireless network;
decrypting the secure audio messages into audio communications; and
playing the audio communications to the user.

12. The computer program of claim 10, wherein the predefined algorithm is a type-4 encryption algorithm.

13. The computer program of claim 10, wherein the predefined algorithm is an Advanced Encryption Standard compatible algorithm.

14. An apparatus capable of providing a secure end-to-end audio communications in a wireless communication network, the apparatus comprising:
transceiving means for transmitting and receiving secure audio messages to and from the wireless communication network;
controlling means in communication with the transceiving means for receiving the secure audio messages;
user interface means in communication with the controlling means for interfacing with a user; and
a computer-readable storage means in communication with the controller, the computer-readable storage means including
means for receiving audio communications from the user, and
means for encrypting the audio communications into secure audio messages according to a predefined algorithm.

15. The apparatus of claim 14, wherein the computer-readable storage means further including:
means for receiving the secure audio messages from the controlling means, and
means for decrypting the secure audio messages into audio communications according to the predefined algorithm.

16. The apparatus of claim 14, wherein the means for encrypting the audio communications is compatible with the Binary Runtime Environment for Wireless (BREW) standard.

17. The apparatus of claim 14, wherein the predefined algorithm is a type-4 encryption algorithm.

18. The apparatus of claim 14, wherein the predefined algorithm is an Advanced Encryption Standard compatible algorithm.

19. A method for providing replacing an encryption algorithm for secure audio communications on a wireless communication device in communication with a server through a wireless communication network, wherein the wireless communication device having a computer readable memory, the method comprising the steps of:
receiving an encryption application program from the server, the encryption application program having an encryption algorithm; and
encrypting audio communications into secure audio messages according to the encryption algorithm.

20. The computer program of claim 19, further performs the step of transmitting the secure audio messages from the wireless communication device to the wireless communication network.

21. The computer program of claim 19, further performs the step of storing the encryption application program in the computer readable memory.
